(19) United States
(12) Patent Application Publication
(10) Pub. No.: US 2002/0107460 A1
(43) Pub. Date: Aug. 8, 2002

(54) Intraoral myofascial release tool

(76) Inventor: Jeanne Scheele, Arlington, VA (US)

Correspondence Address: Law Offices of William H. Holt, Unit 2 - First Floor, 1423 Powhatan Street, Alexandria, VA, 22314, US

(21) Appl. No.: 10/061,322

(22) Filed: Feb. 4, 2002

Related U.S. Application Data
(60) Provisional application No. 60/265,896, filed on Feb. 5, 2001.

(51) Int. Cl. A61H 7/00

(52) U.S. Cl. 601/135; 601/138

(57) ABSTRACT

A massage tool for alleviating pain caused by temporomandibular (TMJ) dysfunction of a person's jaw. The tool is particularly useful for applying pressure on muscle trigger points to release the medial pterygoid and inferior lateral pterygoid muscles. An engagement surface at one end thereof is preferably formed of resilient material and has a slightly elongated, rectangular engagement area for pressing upon tissue and causing temporary eschemia.

### BACKGROUND OF THE INVENTION

A person's jaw joint is more technically called the temporomandibular joint or, for short, the TMJ. The name comes from the two bones which make up the joint, namely, the “temporal bone” of the skull and the “mandible bone” of the jaw which fit together to form a somewhat hinge-like connection.

Temporomandibular joint (TMJ) syndrome, or dysfunction, can affect a person's head, jaw, and face, and even other portions of the body, and is characterized by pain and other neurologic symptoms that are caused by incorrect working of the temporomandibular joint, ligaments and jaw muscles, specifically the medial pterygoid and inferior lateral pterygoid muscles and the ligaments that control and support them.

One of the major goals in treating this disorder is aimed at eliminating muscle spasm and relieving the pain resulting therefrom. Headaches, tenderness of the jaw muscles, and dull, aching facial pain with severe exacerbation in or around the ear are common symptoms of temporomandibular joint (TMJ) syndrome.

In the past, this condition has been treated by, for example, applying moist heat to the patient's face, particularly upon the cheek, or by administering muscle-relaxant drugs, or by massaging the adjacent muscles. In the treatment of the disorder by massaging the muscle(s), release procedures have been used to desensitize and inactivate myofascial trigger points. At times, this has been accomplished by the use of the patients' index finger to press on the muscles to cause a localized release of the shortened muscle segments. This localized release of myofascial tension reduces the biomechanical pressure caused by the shortened segments. The resultant muscle relaxation encourages a copious return of blood and oxygen, overcomes an ischemic effect, dramatically elevates pain threshold, and encourages and promotes healthy, compliant tissue.

Some problems associated with the use of the index finger are, for example, (1) introduction of dirt, germs or other contamination, (2) the size of the person's fingers may be too large or too small and, therefore, not a proper size to be effective, (3) the necessary technique is difficult to teach and may be improperly applied by the patient, (4) the patient's fingernails can cut tissue or cause other damage, and (5) it is not socially acceptable to place fingers in one's mouth in public, such as in restaurants, offices, or during business or social meetings, and the like.

### SUMMARY OF THE INVENTION

This invention relates to a therapeutic instrument, or device, and more particularly to an intra-oral massage tool for use in alleviation of the pain associated with temporomandibular (TMJ) dysfunction.

It is an object of this invention to provide a massage tool which is of simple, yet rugged construction, and that may be used without danger of damaging a person's teeth or inner mouth and is hygienic, easy to clean, and can be used in a generally unobtrusive manner.

The novel tool is used primarily for applying pressure on muscle trigger points, specifically the medial pterygoid and inferior lateral pterygoid muscles, thus creating temporary ischemia. Upon release of pressure upon the tool, blood flows into the muscle and results in quickly reducing or alleviating the pain. Once a patient is taught the technique of how to use the massage tool, by a physical therapist or a dentist, the tool of this invention is quite useful as part of a long term, self-treatment program in addition to being useful for quickly relieving acute pain.

A further object of the invention is to provide a novel massage tool wherein a handle portion thereof is non-circular in section, preferably generally rectangular or oval, for promoting stability and for allowing the user to obtain a firm grip and also to facilitate controlled orientation of the tool during use.

Another object of the invention is to provide one embodiment of intra-oral massage tool with a thin, protective coating, at least along a portion of a length adjacent the operative end thereof, to aid in maintaining cleanliness and a generally hygienic condition.

A still further object of the invention is to provide the novel massage tool with a convenient cap or cover member for improving and maintaining hygienic conditions associated with the tool and, preferably, providing the cap or cover member with a clip for holding it in place in one's pocket or purse, or the like.

### BRIEF DESCRIPTION OF THE DRAWINGS

FIG. 1 shows a perspective side view of an intra-oral, myofascial release, massage tool in accordance with the present invention.

FIG. 2 is a fragmentary sectional view of the intra-oral myofascial release tool, taken on line 2-2 of FIG. 1.

FIG. 3 is an end view of the intra-oral myofascial release tool showing an elongated surface of generally rectangular shape.

FIG. 4 shows the provision of a cover in the form of a cap for containing and covering the intra-oral myofascial release tool, particularly the operative portion thereof, and a clip for securing the tool in a pocket, or the like.

### DESCRIPTION OF THE PREFERRED EMBODIMENT

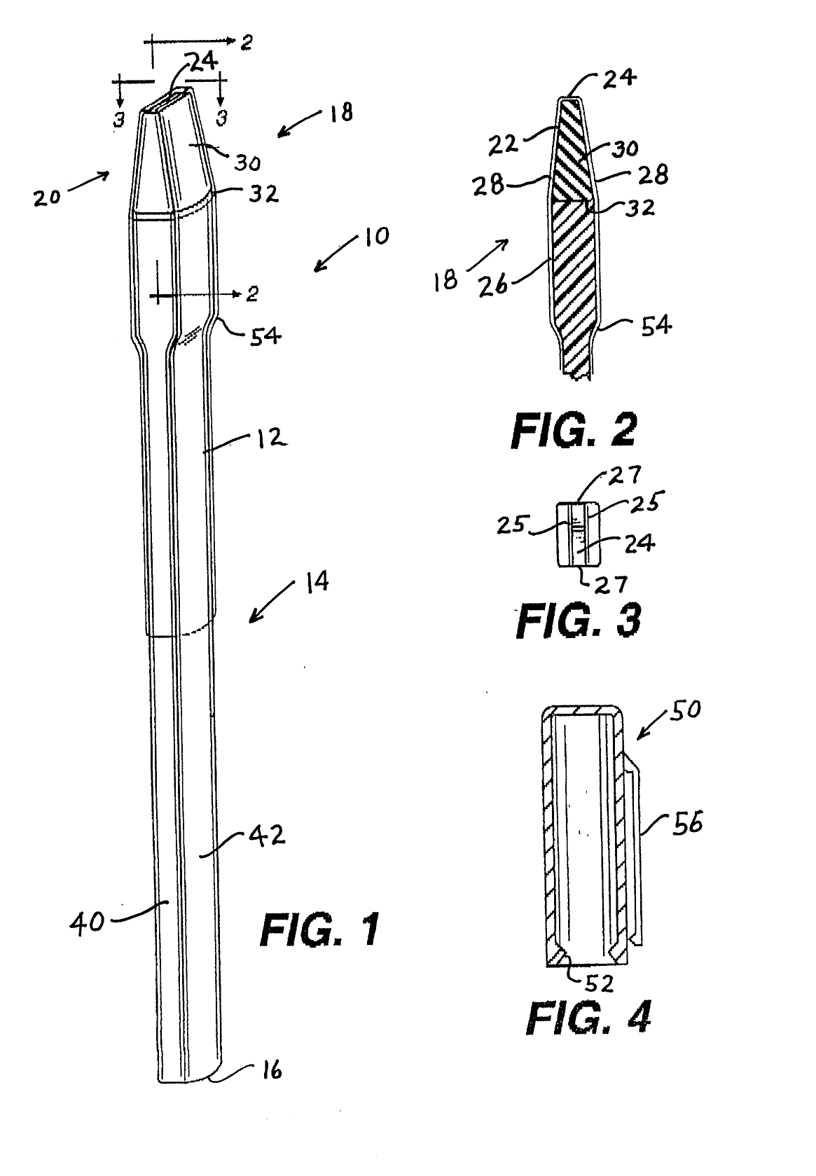

An oral massage tool, generally indicated by the numeral 10, is very useful for alleviating pain caused by temporomandibular (TMJ) dysfunction of a person's jaw. The massage tool 10 comprises a tool body 12 having a longitudinally extending handle portion 14 having a free end 16 at one end and a head portion 18 located opposite from the free end 16. The head portion 18 includes a massage head 20 preferably formed of resilient or slightly yielding material such as rubber or the like. Massage head 20 includes a tapered end 22 terminating in a generally rectangular engagement surface 24 at the terminus of converging side surfaces 28. Engagement surface 24, as best shown in FIG. 3, includes two long sides 25 and two short sides 27 forming the generally rectangular engagement surface or area 24 that may be flat or slightly rounded. Head portion 18 may have an outer surface 26 formed of a thin coating of material, such as plastic or the like, that can be easily cleaned for hygienic purposes, Head portion 18 may be constructed to have a yieldable head member 30 which, as best shown in FIG. 1 and FIG. 2, can be a separate piece secured to and removable from handle portion 14 through the use of a layer 32 of pressure sensitive adhesive. Other fastening means such as a threaded fastener, not shown, may be used in order to simplify manufacturing and to allow for replacing head member 30.

Handle portion 14 is preferably non-circular in transverse section; rather, it can have a flat surface 40 and/or a rounded surface 42 thus being somewhat oval or rectangular to assist the user in orienting the position of massage head 20 in the space between the user's teeth or gum and the cheek, and to provide a firmer grip than is provided by a cylindrical handle portion.

Head portion 18 can be conveniently contained within a cap 50 which is provided with a shoulder 52, as shown in FIG. 4, that cooperates with a complementary shoulder 54 at the terminus of the head portion 18. The cap 50 has a clip 56 for being secured to a person's pocket and/or within a person's purse for convenience and for protecting head portion 18 against contamination.

It is to be understood that the foregoing description allows for various modifications in materials and shape. Accordingly, the spirit and scope of the invention is to be limited only by the following claimed subject matter.

I claim:

1. A massage tool 10 for alleviating pain caused by temporomandibular (TMJ) dysfunction of a person's jaw, said tool comprising a tool body 12 having a longitudinally extending handle portion 14, said handle portion having a free end 16 and a head portion 18 opposite from said free end, and a massage head 20 forming part of said head portion and having a tapered end 22 terminating in an engagement surface 24.

2. A massage tool as defined in claim 1 wherein at least said head portion 18 has an outer surface of hygienically cleanable plastic 26, said massage head being formed of resilient material and having converging side surfaces 28 leading to and ending at said engagement surface 24.

3. A massage tool as defined in claim 1 wherein said massage head 20 includes a yieldable massage head member 30 having side surfaces 28 converging for forming a narrow end portion 27.

4. A massage tool as defined in claim 3 wherein said narrow end portion 27 includes two long sides 25 and two short sides 27 forming said engagement surface 24 with a generally rectangular engagement area.

5. A massage tool as defined in claim 3 wherein said handle portion 14 is generally rectangular in transverse section and is flexible for yielding under pressure.

6. A massage tool as defined in claim 3 in combination with a cap 50 covering at least said massage head 20 and wherein said head portion 18 includes a shoulder portion 54 for engagement with said cap for securing said cap to said handle portion 14.

7. A massage tool as defined in claim 3 wherein said handle portion 14 includes at least one generally non-circular surface 42 for aiding in orientation of said engagement surface 24.

8. A massage tool as defined in claim 1 wherein said massage head member 20 is composed of resilient rubber.

9. A massage tool as defined in claim 1 wherein said massage head 20 is removable from said head portion 18.
